(19) United States
(12) Patent Application Publication
(10) Pub. No.: US 2013/0016656 A1
(43) Pub. Date: Jan. 17, 2013

(54) MOBILE STATION AND TRANSMISSION CONTROL METHOD

(71) Applicant: Hideyori SATOU, Yokosuka (JP)

(72) Inventor: Hideyori SATOU, Yokosuka (JP)

(73) Assignee: FUJITSU LIMITED, Kawasaki-shi (JP)

(21) Appl. No.: 13/477,147

(22) Filed: May 22, 2012

(30) Foreign Application Priority Data
Jul. 11, 2011 (JP) 2011-153070

(51) Int. Cl. H04W 56/00; H04W 74/08

(52) U.S. Cl. 370/328

(57) ABSTRACT

A mobile station includes: a determining unit configured to make a determination as to whether uplink synchronization is established with a base station; a controller configured to determine a timing for providing notification of a start of data transmission to the base station based on a result of a determination; and a transmitting unit configured to provide the notification of the start of data transmission to the base station at the timing.

### CROSS-REFERENCE TO RELATED APPLICATION(S)

This application is based upon and claims the benefit of priority of the prior Japanese Patent Application No. 2011-153070, filed on Jul. 11, 2011, the entire contents of which are incorporated herein by reference.

### FIELD

The embodiments discussed herein are related to a mobile station and a transmission control method.

### BACKGROUND

In techniques for radio communication between base and mobile stations, a mobile station may use a random access channel (RACH) shared with other mobile stations to access a base station. In RACH transmission control, the mobile station performs preamble transmission which requests the start of scheduling in order to notify the base station of the presence of uplink transmission data. The preamble transmission may be executed substantially at the same timing as downlink data reception. Upon receipt of a frame of the preamble transmission, the base station measures a round-trip propagation delay time. At the same time, the base station performs transmission timing control which dynamically changes a transmission timing with respect to the timing of downlink data reception.

Related art is disclosed, for example, in Japanese Laid-open Patent Publication Nos. 2009-153048 and 2008-244526.

### SUMMARY

According to an aspect of the invention, a mobile station includes: a determining unit configured to make a determination as to whether uplink synchronization is established with a base station; a controller configured to determine a timing for providing notification of a start of data transmission to the base station based on a result of a determination; and a transmitting unit configured to provide the notification of the start of data transmission to the base station at the timing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary mobile station;

FIG. 2 illustrates an exemplary mobile phone;

FIG. 3 illustrates an exemplary operation of a mobile station;

FIG. 4 illustrates an exemplary transmission timing control;

FIG. 5 illustrates an exemplary transmission timing control;

FIG. 6 illustrates an exemplary uplink non-synchronized state; and

FIG. 7 illustrates an exemplary computer.

### DESCRIPTION OF EMBODIMENTS

In RACH transmission control, a mobile station initializes a timing advance (TA) to notify a base station of a round-trip delay time. For example, regardless of whether uplink synchronization is established with the base station, the mobile station performs preamble transmission substantially at the same timing (initial TA=0) as a downlink data reception timing. For example, in an uplink synchronized state, if there is a significant difference between a previous transmission timing and the transmission timing obtained by the TA initialization (initial value), the mobile station may significantly change the timing of preamble transmission. Thus, since the mobile station stops transmission of data and ACK/NACK before and after the preamble transmission, the base station may be unable to properly receive data during a period of over ten milliseconds to several tens of milliseconds between the preamble transmission and the establishment of the transmission timing.

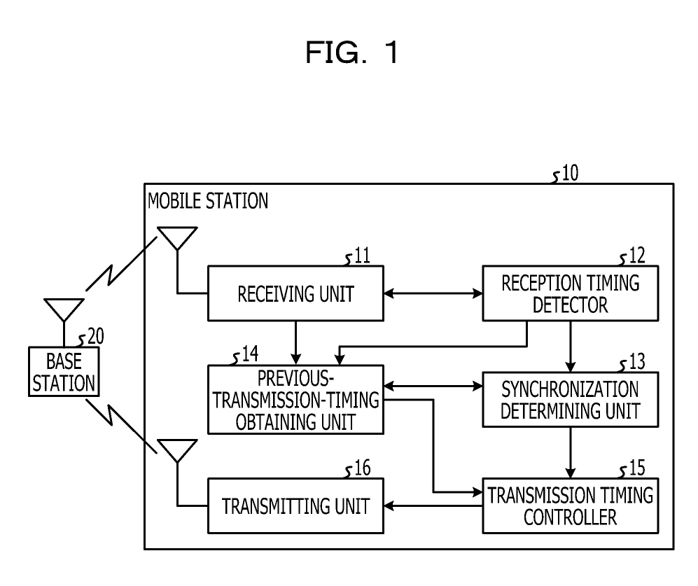

FIG. 1 illustrates an exemplary mobile station. A mobile station 10 includes a receiving unit 11, a reception timing detector 12, a synchronization determining unit 13, a previous-transmission-timing obtaining unit 14, a transmission timing controller 15, and a transmitting unit 16. These components may be coupled in a way which allows one-way or two-way input and output of signals and data.

In normal communication in the mobile station 10, the receiving unit 11 receives downlink data transmitted from a base station 20 to the mobile station 10. In preamble transmission, upon detection of a timing for receiving downlink data, the receiving unit 11 receives TA information from the base station 20. The TA information indicates a time difference between a subframe transmission timing and a subframe reception timing.

The reception timing detector 12 monitors a downlink subframe and detects a timing for the mobile station 10 to receive retransmitted downlink data from the downlink subframe. Then, the reception timing detector 12 notifies the receiving unit 11 and the synchronization determining unit 13 of the detected reception timing.

Based on the notification of the reception timing detected by the reception timing detector 12, the synchronization determining unit 13 determines whether uplink synchronization is established between the mobile station 10 and the base station 20. If the synchronization is established, the synchronization determining unit 13 notifies the previous-transmission-timing obtaining unit 14 that the synchronization is established. If the synchronization is not established, the synchronization determining unit 13 notifies the transmission timing controller 15 that the synchronization is not established.

If uplink synchronization is established between the mobile station 10 and the base station 20, the previous-transmission-timing obtaining unit 14 obtains the previous uplink transmission timing as a reference for a preamble transmission timing.

The transmission timing controller 15 variably determines the preamble transmission timing depending on whether uplink synchronization is established between the mobile station 10 and the base station 20. For example, if uplink synchronization is established, the transmission timing controller 15 does not perform TA initialization and determines the preamble transmission timing, which provides notification of the start of data transmission to the base station 20, using the previous transmission timing as a reference. If uplink synchronization is not established, since there is no uplink reference, the transmission timing controller 15 sets an offset value of the transmission timing to “0” for TA initialization. The preamble transmission timing in an uplink synchronized state is controlled such that it follows the preceding subframe without interruption. The preamble transmission timing in an uplink non-synchronized state is controlled such that it coincides with a subframe reception timing.

The transmitting unit 16 transmits a preamble signal to the base station 20 as a request for scheduling. Based on the transmission timing controlled by the transmission timing controller 15, the transmitting unit 16 performs uplink data transmission corresponding to the request for scheduling.

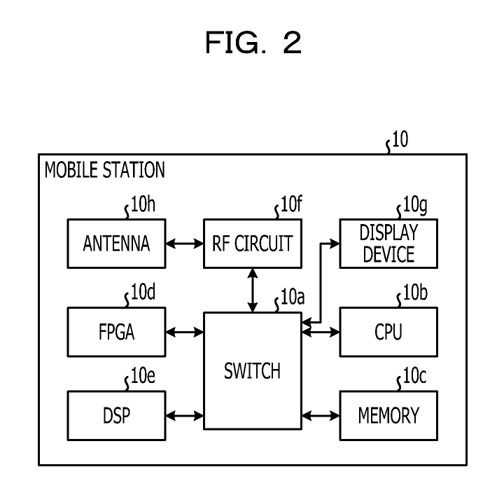

The mobile station 10 may be, for example, a mobile phone. FIG. 2 illustrates an exemplary mobile phone. FIG. 2 may illustrate a hardware configuration of the mobile phone. In the mobile station 10 illustrated in FIG. 2, a central processing unit (CPU) 10b, a memory 10c, a field programmable gate array (fpga) 10d, a digital signal processor (dsp) 10e, a radio frequency (rf) circuit 10f, and a display device 10g are coupled via a switch 10a in a way which allows input and output of various signals and data. The RF circuit 10f includes an antenna 10h. The memory 10c may be, for example, a synchronous dynamic random access memory (SDRAM), a read only memory (ROM), or a flash memory. The display device 10g may be, for example, a liquid crystal display (LCD) or an organic electroluminescence (EL) display. The receiving unit 11 and the transmitting unit 16 of the mobile station 10 may correspond to, for example, the RF circuit 10f and the antenna 10h. The reception timing detector 12, the synchronization determining unit 13, the previous-transmission-timing obtaining unit 14, and the transmission timing controller 15 may correspond to, for example, the CPU 10b or the DSP 10e.

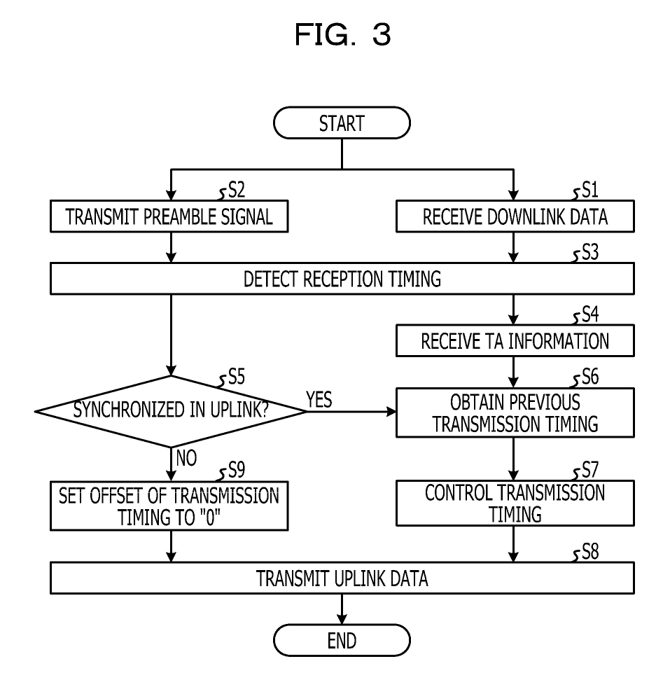

FIG. 3 illustrates an exemplary mobile station. For example, in normal communication, the mobile station 10 receives downlink data addressed to the mobile station 10 from the base station 20 (operation S1).

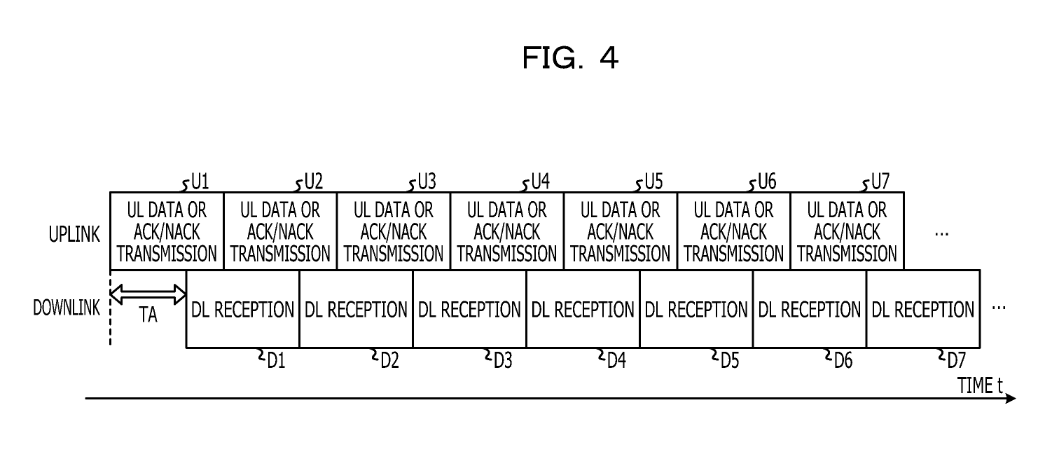

FIG. 4 illustrates an exemplary transmission timing control. FIG. 4 may illustrate the transmission timing control performed in normal communication. The x-axis direction in FIG. 4 represents time. An uplink signal and a downlink signal are transmitted and received on a subframe-by-subframe basis, for example, in 1 millisecond over a channel. A predetermined time period of timing advance (TA) is set between a series of uplink subframes U1 to U7 and a series of downlink subframes D1 to D7. Uplink synchronization between the mobile station 10 and the base station 20 may be established based on the TA. If the mobile station 10 properly receives data contained in a subframe from the base station 20, the mobile station 10 returns an ACK signal representing a positive acknowledgement via an uplink channel using a subframe. If the mobile station 10 fails to properly receive downlink data, the mobile station 10 returns a NACK signal representing a negative acknowledgement to the base station 20 from which the data has been transmitted.

In an operation S2 illustrated in FIG. 3, the mobile station 10 transmits a preamble signal. The mobile station 10 uses the preamble signal to notify the base station 20 that there is untransmitted uplink data. Based on the notification, the base station 20 starts scheduling for the mobile station 10.

Upon detection of a timing for receiving retransmitted downlink data (an operation S3), the mobile station 10 receives, from the base station 20, information about the TA (see FIG. 4) which represents a time difference between an uplink subframe transmission timing and a downlink subframe reception timing (an operation S4). In response to the timing detection in the operation S3, the synchronization determining unit 13 of the mobile station 10 starts to determine whether uplink synchronization is established (an operation S5). If uplink synchronization is established (YES in the operation S5), upon detection of uplink data generation, the mobile station 10 obtains the previous transmission timing as a reference for the preamble transmission timing (an operation S6).

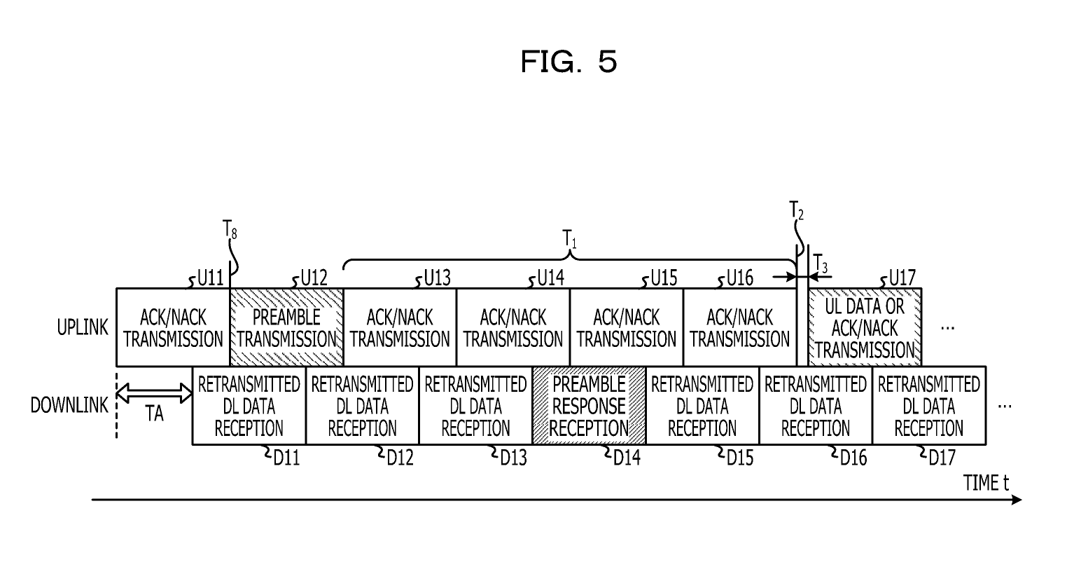

In the operation S7, the mobile station 10 adjusts the preamble transmission timing to the previous transmission timing. For example, the mobile station 10 performs preamble transmission addressed to the base station 20 by using, as a reference, a previous transmission timing in an uplink synchronized state, such as the previous transmission timing. FIG. 5 illustrates an exemplary transmission timing control. The transmission timing control illustrated in FIG. 5 may be that performed in preamble transmission in an uplink synchronized state. The preamble transmission is performed at a timing in which the beginning of subframe U12 for transmitting a preamble coincides with the end of subframe U11 for the previous ACK/NACK transmission. Thus, there may be no temporal interruption between subframes U11 and U12. Since there is no interruption between adjacent ones of subframes U13 to U16 that follow the preamble, efficient subframe transmission with less time lag may be performed.

In an operation S7, since uplink synchronization is established between the mobile station 10 and the base station 20, the base station 20 properly receives subframes U13 to U16 transmitted during period T₁ illustrated in FIG. 5. Since there is a small time difference (or gap) between timing T₂ (at a boundary between periods T₁ and T₃) serving as a reference for TA control and uplink transmission subframe U17, period T₃ may fall within a guard interval (cyclic prefix (CP)). Therefore, when updating the TA and transmitting uplink data, the transmission timing controller 15 of the mobile station 10 may make fine adjustment of period T₃ without using a subframe.

In an operation S8 illustrated in FIG. 3, the mobile station 10 starts uplink data transmission which is indicated, for example, by the preamble transmission under the transmission timing control illustrated in FIG. 5.

If uplink synchronization is not established for the reception timing detected in the operation S3 (NO in the operation S5), since there is no reference for the preamble transmission timing, the mobile station 10 initializes the TA to perform preamble transmission (an operation S9). The preamble transmission timing in a synchronized state may be controlled such that it follows the preceding subframe without interruption, for example, such that there is an offset. The preamble transmission timing in a non-synchronized state is controlled such that it coincides with a subframe reception timing, for example, such that the offset becomes “0”.

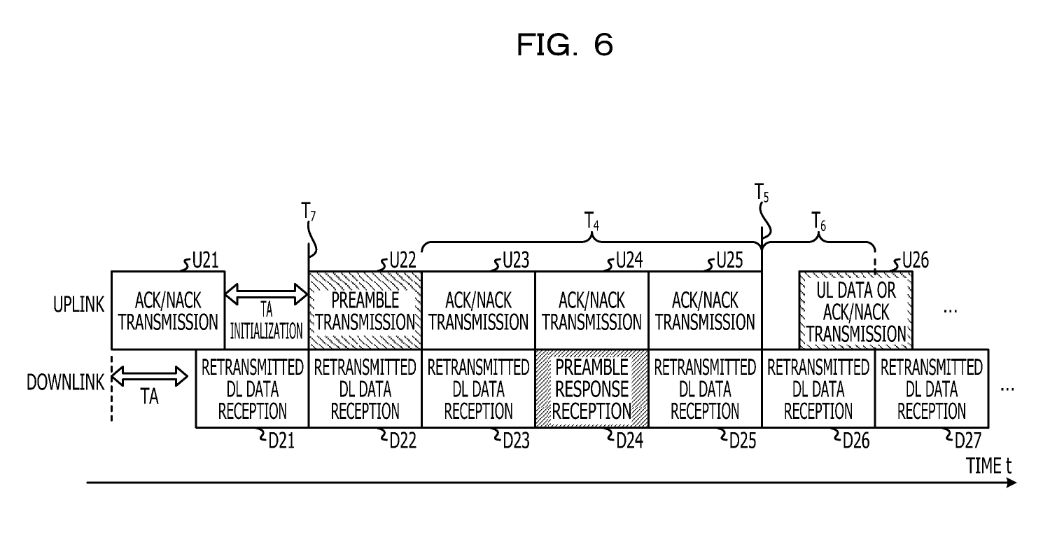

FIG. 6 illustrates an exemplary uplink non-synchronized state. FIG. 6 may illustrate transmission timing control performed in preamble transmission. For example, as illustrated in FIG. 6, if uplink synchronization is not established between the mobile station 10 and the base station 20, the mobile station 10 sets an offset value of the transmission timing to “0” to initialize TA before preamble transmission. A transmission timing of subframe U22 for preamble transmission may coincide with a reception timing of subframe D22 for downlink reception. The mobile station 10 uses subframe U26 and later subframes to perform uplink data transmission indicated by the preamble transmission (the operation S8).

The mobile station 10 includes the synchronization determining unit 13, the transmission timing controller 15, and the transmitting unit 16. The synchronization determining unit 13 determines whether uplink synchronization is established with the base station 20. If uplink synchronization is established, the transmission timing controller 15 determines a timing for providing notification of the start of data transmission to the base station 20, such as the presence of data to be transmitted, by using a previous transmission timing as a reference. The transmitting unit 16 notifies the base station 20 of the start of data transmission at the timing determined by the transmission timing controller 15. If there is a significant difference between a previous transmission timing and the transmission timing obtained by TA initialization (initial value), the amount of change in timing of preamble transmission may be reduced. Without stopping transmission of data and ACK/NACK before and after the preamble transmission, the mobile station 10 transmits, to the base station 20, data or a signal to be properly received by the base station 20. The stopping of uplink transmission information is reduced and a reduction in uplink and downlink throughput is reduced. Since the amount of change in transmission timing is reduced, the transmission timing control in the mobile station 10 is simplified and the processing load of the mobile station 10 is reduced.

In the transmission timing control in the mobile station 10, the preamble transmission timing may not be the timing for receiving retransmitted data, such as time point T₇ in FIG. 6, but may be a previous transmission timing in an uplink synchronized state, such as time point T₈ in FIG. 5. Since an uplink non-synchronized state is not established in the former timing (time point T₇ in FIG. 6), the base station 20 may not receive a reception timing corresponding to the preamble transmission performed by the mobile station 10. The base station 20 may fail to properly receive subframes U23 to U25 transmitted during period T₄ and may recognize them as noise. As illustrated in FIG. 6, there is a significant time difference between time point T₅ (at a boundary between periods T₄ and T₆) serving as a reference timing for TA control and uplink transmission subframe U26. The time difference may not fall within a guard interval. Therefore, when updating the TA, the mobile station 10 may reserve a resource for transmitting uplink data, such as subframe U26 and later subframes, by using one subframe of transmission corresponding to period T₆. Since the number of gaps on the channel in the direction of time is reduced at the latter timing (time point T₈ in FIG. 5) in an uplink synchronized state, the mobile station 10 may effectively use the channel during data transmission to the base station 20.

The timing for the mobile station 10 to provide notification of the start of data transmission may be a preamble transmission timing in RACH control. The mobile station 10 may execute RACH control of transmission timing follow-up type. For example, the mobile station 10 may perform RACH control, with the preamble transmission timing adjusted not to the initial value (downlink data reception timing) but to the previous transmission timing. In RACH transmission control, to notify the base station 20 of the presence of uplink transmission data, the mobile station 10 performs preamble transmission which requests the start of scheduling before data transmission to the base station 20. The above-described technique may be applied to the preamble transmission in RACH control. In the preamble transmission in RACH control, since there are many subsequent pieces of untransmitted uplink data, high-speed high-quality communication resources may be reserved between the mobile station 10 and the base station 20. Since the above-described technique is applied to the preamble transmission in RACH control, the mobile station 10 effectively uses the allocated communication resources to transmit data to the base station 20. When the mobile station 10 transmits a large amount of data after preamble transmission, a high level of throughput may be maintained.

The mobile station 10 determines the timing of preamble transmission by using the previous transmission timing as a reference. Therefore, the transmitting unit 16 may transmit ACK or NACK to the base station 20 in the period between the preamble transmission and the data transmission. Subframes present between a subframe for advance notice of the start of data transmission and a subframe used for actual data transmission may not be wasted in radio communication between the mobile station 10 and the base station 20. Thus, the mobile station 10 may use many subframes for transmission to the base station 20. A reduction in throughput associated with preamble transmission after TA initialization may be reduced.

The process described above may be carried out through execution of a program by a computer.

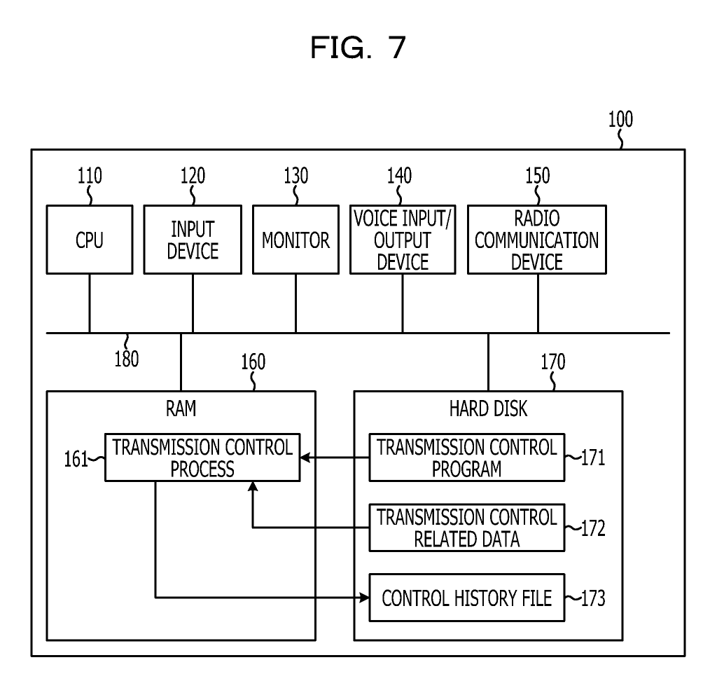

FIG. 7 illustrates an exemplary computer. The computer illustrated in FIG. 7 may execute a transmission control program. A computer 100 includes a CPU 110, an input device 120, a monitor 130, a voice input/output device 140, and a radio communication device 150. The computer 100 further includes data storage devices, such as a RAM 160 and a hard disk 170. These components of the computer 100 are coupled via a bus 180. The CPU 110 executes various computations. The input device 120 receives data input from the user. The monitor 130 displays various kinds of information. The voice input/output device 140 inputs and outputs voice. The radio communication device 150 transmits and receives data to and from other computers via radio communication. The RAM 160 temporarily stores various kinds of information.

The hard disk 170 may store a transmission control program 171 having a function substantially the same as or similar to that of the CPU 10b illustrated in FIG. 2. The hard disk 170 also stores various kinds of data stored in the memory 10c illustrated in FIG. 2, for example, previous transmission timing, preamble transmission data and transmission control related data 172 and a control history file 173 corresponding to transmission timing.

The transmission control program 171 read from the hard disk 170 and expanded in the RAM 160 by the CPU 110 may correspond to a transmission control process 161. The transmission control process 161 appropriately expands information read from the transmission control related data 172 in an allocated space in the RAM 160, and executes various kinds of data process based on the expanded information. The transmission control process 161 outputs predetermined information to the control history file 173.

The transmission control program 171 may be stored on the hard disk 170 or a storage medium, such as a compact-disk read-only memory (CD-ROM). The transmission control program 171 may be stored on another computer or a server coupled to the computer 100 via a public line, the Internet, a local area network (LAN), or a wide area network (WAN). The computer 100 reads and executes the transmission control program 171.

When performing preamble transmission for determining a transmission timing, the mobile station 10 may use the previous transmission timing as a reference. The mobile station 10 may use, as a reference timing, a previous transmission timing in an uplink synchronized state within the same cell. A transmission timing used by the mobile station 10 as a reference for preamble transmission may be the previous transmission timing, or another previous transmission timing in an uplink synchronized state within the same cell. For example, the mobile station 10 may use the second previous or earlier transmission timing as a reference.

Examples of the mobile station 10 may include mobile phones, smartphones, and personal digital assistants (PDAs). The technique described above may be applied to communication equipment that performs transmission timing control.

All or some components of the mobile station 10 may be functionally or physically distributed or integrated in any units depending on various loads or use conditions. For example, the reception timing detector 12, the synchronization determining unit 13, and the previous-transmission-timing obtaining unit 14 may be integrated into a single element. The transmission timing controller 15 may be distributed in two parts, one part which executes control when uplink synchronization is established and the other part which executes control when uplink synchronization is not established. The memory 10c may be coupled as an external device to the mobile station 10 via a network or a cable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile station comprising:
a determining unit configured to make a determination as to whether uplink synchronization is established with a base station;
a controller configured to determine a timing for providing notification of a start of data transmission to the base station based on a result of a determination; and
a transmitting unit configured to provide the notification of the start of data transmission to the base station at the timing.

2. The mobile station according to claim 1, wherein the controller sets the timing for providing notification of the start of data transmission to a previous timing of data transmission to the base station if the uplink synchronization is established.

3. The mobile station according to claim 1, wherein the controller sets an offset of the timing for providing notification of the start of data transmission to an initial value if the uplink synchronization is not established.

4. The mobile station according to claim 2, wherein if there are a plurality of previous timings of data transmission to the base station, one of the previous timings is selected and set as the timing for providing notification of the start of data transmission.

5. A transmission control method performed by a mobile station, the transmission control method comprising:
making a determination as to whether uplink synchronization is established with a base station;
determining a timing for providing notification of a start of data transmission to the base station based on a result of a determination; and
providing the notification of the start of data transmission to the base station at the timing.

6. The transmission control method according to claim 5, further comprising,
setting the timing for providing notification of the start of data transmission to a previous timing of data transmission to the base station if the uplink synchronization is established.

7. The transmission control method according to claim 5, further comprising,
setting an offset of the timing for providing notification of the start of data transmission to an initial value if the uplink synchronization is not established.

8. The transmission control method according to claim 6, further comprising,
if there are a plurality of previous timings of data transmission to the base station, selecting one of the previous timings to set a selected one as the timing for providing notification of the start of data transmission.

9. The transmission control method according to claim 5, transmitting predetermined information to the base station after the notification to the base station and before the start of data transmission.
